(19) United States
(12) Patent Application Publication
(10) Pub. No.: US 2021/0073464 A1
(43) Pub. Date: Mar. 11, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Toshiyuki KOMODA, Kanagawa (JP)

(73) Assignee: FUJI XEROX CO., LTD., Tokyo (JP)

(21) Appl. No.: 16/805,910

(22) Filed: Mar. 2, 2020

(30) Foreign Application Priority Data
Sep. 11, 2019 (JP) 2019-165566

(51) Int. Cl. G06F 40/197; G06F 40/166

(52) U.S. Cl. CPC G06F 40/197; G06F 40/166

(57) ABSTRACT

An information processing apparatus includes an editing reception unit and a providing unit. The editing reception unit provides to each user an editing screen on which at least one part of a document is displayed and receives from the user editing on the at least one part of the document displayed on the editing screen being provided to the user. The providing unit provides to the user information regarding editing currently being performed by a different user on a part of the document not displayed on the editing screen being provided to the user.

### CROSS-REFERENCE TO RELATED APPLICATIONS

This application is based on and claims priority under 35 USC 119 from Japanese Patent Application No. 2019-165566 filed Sep. 11, 2019.

### BACKGROUND

### (i) Technical Field

The present disclosure relates to an information processing apparatus and a non-transitory computer readable medium.

### (ii) Related Art

Systems that are capable of editing the same document by a plurality of users using different terminals at the same time have been available. Furthermore, some systems of this type display, on an editing screen on which a part of a document being edited by a user (for example, a page that is being edited), results of editing on the part by other users or contents of editing currently being performed on the page by other users.

In an apparatus described in Japanese Unexamined Patent Application Publication No. 11-306173, when a change is made to a document stored in a shared document storing unit, change information managing means detects an operator who has edited the document in the past from editing history storing means and transmits a change notification that is different depending on whether the latest history by the operator represents one immediately before the current history or before the one immediately before the current history. When an operator who has received the change notification makes a request for browsing of a change status of the document, browsing request managing means searches operating status storing means. In the case where a person who has made the change keeps editing the document, the operating status of the editing is presented to the person who has made the request for browsing. In the case where editing of the document is finished, a corresponding changed part is presented to the person who has made the request for browsing, and the person who has made the change is notified that the document is being browsed. When the person who has made the change inputs information indicating that the person who has made the change recognizes the browsing, browsing recognition information notifying means notifies the person who has made the request for browsing of the information indicating that the person who has made the change recognizes the browsing.

In Japanese Unexamined Patent Application Publication No. 2011-248485, a technique is described in which a group wear system that receives collaborative editing on the same document highlights an updated field when a user first accesses an updated document.

In Japanese Unexamined Patent Application Publication No. 5-113975, a technique is described in which for convenience in sharing among a plurality of people or groups, a changed part and changed contents of a document are displayed in association with comments.

### SUMMARY

Aspects of non-limiting embodiments of the present disclosure relate to a disadvantage in that a user is not able to know, in the case where contents of editing being performed by a different user on only a part displayed on an editing screen presented to the user are displayed on the editing screen, editing currently being performed by a different user on a part not displayed on the editing screen.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including an editing reception unit and a providing unit. The editing reception unit provides to each user an editing screen on which at least one part of a document is displayed, and receives from the user editing on the at least one part of the document displayed on the editing screen being provided to the user. The providing unit provides to the user information regarding editing currently being performed by a different user on a part of the document not displayed on the editing screen being provided to the user.

### BRIEF DESCRIPTION OF THE DRAWINGS

Exemplary embodiments of the present disclosure will be described in detail based on the following figures, wherein:

FIG. 1 is a diagram illustrating an example of a system configuration in an exemplary embodiment;

FIG. 2 is a diagram illustrating an example of a process performed by a document management system;

FIG. 3 is a diagram illustrating an example of an editing screen provided to a client by the document management system;

FIG. 4 is a diagram illustrating another example of the editing screen provided to a client by the document management system;

FIG. 5 is a diagram illustrating still another example of the editing screen provided to a client by the document management system;

FIG. 6 is a diagram illustrating another example of the process performed by the document management system; and

FIG. 7 is a diagram illustrating an example of the details of processing in the process illustrated in FIG. 6.

### DETAILED DESCRIPTION

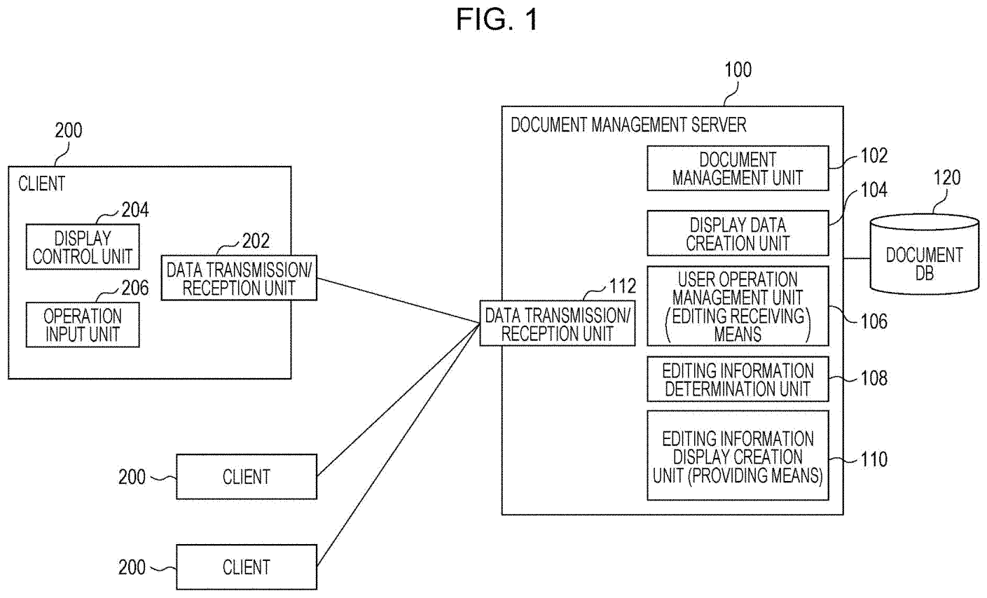

FIG. 1 illustrates an example of a system including a document management server 100 as an information processing apparatus according to an exemplary embodiment of the present disclosure.

This system includes the document management server 100 and a plurality of clients 200.

The document management server 100 manages one or more electronic documents (hereinafter, simply referred to as documents). The document management server 100 includes a collaborative editing function for receiving editing on a document under the management of the document management server 100 by a plurality of users at the same time. A document group managed by the document management server 100 is stored in a document database (DB) 120. Users operate the corresponding clients 200 to browse and edit a document managed by the document management server 100.

The document management server 100 includes a document management unit 102, a display data creation unit 104, a user operation management unit 106, an editing information determination unit 108, an editing information display creation unit 110, and a data transmission/reception unit 112.

The document management unit 102 performs processing for managing a document stored in the document DB 120. The processing for such management includes, for example, processing for reading a document stored in the document DB 120 in accordance with a request from a user and processing for causing editing on the read document performed by the user to be reflected in the corresponding document in the document DB 120.

The display data creation unit 104 generates, using a document read by the document management unit 102 in accordance with a request from a user, display data of various screens to be provided to the user, such as an editing screen for the document. The display data is transmitted to the client 200 by the data transmission/reception unit 112 and displayed on a display device of the client 200.

For example, on an editing screen for a document, an image representing document contents of a part of the document that is selected as the current display region by the user (hereinafter, referred to as an editing range image) is displayed. A display region of a document displayed on the editing screen may be a page or part of a page. Furthermore, the display data creation unit 104 changes document contents displayed on the editing screen in accordance with an editing operation performed by the user and received by the user operation management unit 106, which will be described later.

The user operation management unit 106 receives an operation performed by a user. For example, the user operation management unit 106 receives a log-in operation performed by a user, an operation for selecting a document to be browsed or edited, and an operation for editing a document performed by a user.

The user operation management unit 106 understands, based on an operation received from each user, identification information of a document opened and edited by the user, information indicating an input position in the opened document, and the like. For a word processor document, an input position is defined by the position of a cursor in the document being edited. For a spreadsheet document, the position of a cell selected as an input destination by a user is defined as an input position in the document. Furthermore, the user operation management unit 106 may understand input contents that have been input to an input position by a user but not yet been confirmed. For example, at the stage where input contents such as a character string are input to a cursor position in a document, the user operation management unit 106 holds the input contents in an unconfirmed state. Once a predetermined confirmation operation is performed, the unconfirmed input contents are reflected in a corresponding document in the document DB 120. In other words, when a confirmation operation is performed, input contents are integrated into the corresponding document and stored into the document DB 120. For example, in the case where a document being edited is a spreadsheet, at the point in time when a number or a character is input to a cell as an input target in the spread sheet, the input contents are not yet confirmed and are not reflected in the document DB 120. Then, when a confirmation operation, such as pressing an enter key or setting another cell as an input target, is performed, the input contents are reflected in a corresponding spreadsheet in the document DB 120. A confirmation operation is an operation for instructing that unconfirmed input contents, which exist in a working memory in the client 200, be reflected in a target document in the document DB 120. Such a confirmation operation is, for example, an operation for pressing an enter key, an operation for instructing to store a document, or the like.

Furthermore, the user operation management unit 106 may record an editing history indicating a history of editing performed on a document by each user. For example, a record of an editing history is created and recorded every time that editing is performed (that is, every time that a user inputs an edit and performs a confirmation operation for the input contents). The record includes information of the date and time at which the editing was performed, identification information of a document on which the editing was performed, information of operation contents of the editing, and the like.

The editing information determination unit 108 determines information of a user who is currently editing a document and contents of the editing and information of the editing performed on the document.

Based on information determined by the editing information determination unit 108, the editing information display creation unit 110 adds, to display data of an editing screen for a document provided to a user, display information regarding a different user who is currently editing the document. The editing information display creation unit 110 also adds, to the display data, display information indicating editing performed on a document by a different user after the last time the user closed the document.

The data transmission/reception unit 112 transmits various data such as display data of various screens created by the display data creation unit 104 to the clients 200. The data transmission/reception unit 112 also receives various data representing a request from a user, editing contents of a document, and the like transmitted from the clients 200.

Each of the clients 200 is an information processing apparatus operated by a user and includes a data transmission/reception unit 202, a display control unit 204, and an operation input unit 206.

The data transmission/reception unit 202 receives various data such as display data transmitted from the document management server 100 and transmits information of a request from a user received at the operation input unit 206 and an editing operation on a document to the document management server 100. The data transmission/reception unit 202 is implemented by, for example, various communication protocols provided in an operating system of the client 200.

The display control unit 204 performs control for displaying display data of various screens transmitted from the document management server 100 on the display device of the client 200. The operation input unit 206 receives an operation input from a user to various screens displayed by the display control unit 204. The display control unit 204 and the operation input unit 206 are implemented by, for example, a web browser.

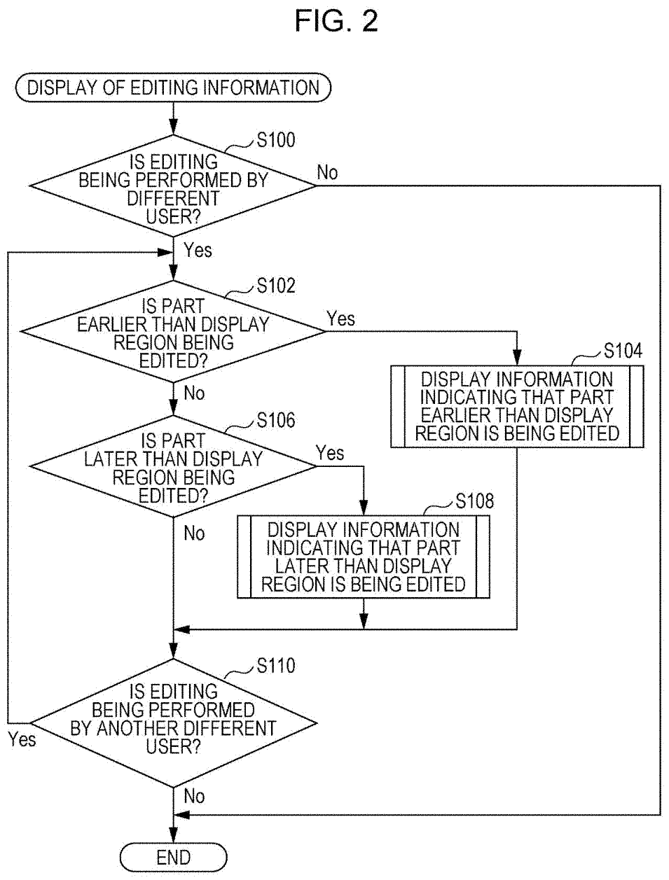

Next, an operation of a process performed by the document management server 100 will be described with reference to FIG. 2. The process is performed for each user who has logged into the document management server 100.

In this process, it is assumed that a user operates the client 200 to log into the document management server 100, selects and opens a document stored in the document DB 120, and performs an operation of browsing and editing. This user will be referred to as a “target user”. A user different from the target user will be referred to as a “different user”. Furthermore, a document opened by the target user will be referred to as a target document. At the point in time when this process is performed, an editing screen on which part of the document is displayed is displayed on the display device of the client 200 of the target user.

The process illustrated in FIG. 2 is performed when the display data creation unit 104 generates display data of an editing screen to be provided to the target user. Generation of display data of an editing screen is performed, for example, periodically. As another example, display data of an editing screen may be generated, triggered by an editing operation or other operations performed on the editing screen by the target user or triggered by an editing operation performed on a target document by a different user.

In the process illustrated in FIG. 2, the editing information determination unit 108 of the document management server 100 determines whether there is a different user who is editing a target document (S100). This determination may be performed by referring to identification information, which is managed by the user operation management unit 106, indicating a document currently being edited by each user.

In the case where only the target user is currently editing the target document, the determination result in S100 is No. In this case, the process illustrated in FIG. 2 ends.

In contrast, in the case where there is a different user who is currently editing the target document, the determination result in S100 is Yes. In this case, the editing information determination unit 108 determines whether the position of an input by the different user who is editing the target document, based on the determination in S100, is earlier (S102) or later (S106) than a part of the target document displayed on the editing screen for the target user (that is, a display region). In the case where the position of the input by the different user is earlier than the display region (the determination result in S102 is Yes), the editing information display creation unit 110 creates display information indicating that the different user is editing a part earlier than the display region, and adds the created display information to the display data of the editing screen (S104). In the case where the position of the input by the different user is later than the display region (the determination result in S106 is Yes), the editing information display creation unit 110 creates display information indicating that the different user is editing a part later than the display region, and adds the created display information to the display data of the editing screen (S108).

In the case where both the determination results in S102 and S106 are No, the position of the input by the different user is within the display region. In this case, the editing information display creation unit 110 displays contents of editing being performed by the different user in the display region of the target document displayed on the editing screen.

After S104 or S108, the editing information determination unit 108 determines whether there is another different user who is editing the target document (S110). In the case where there is another different user who is editing the target document, the process returns to S100. In the case where there are no other users who are editing the target document, the process illustrated in FIG. 2 ends.

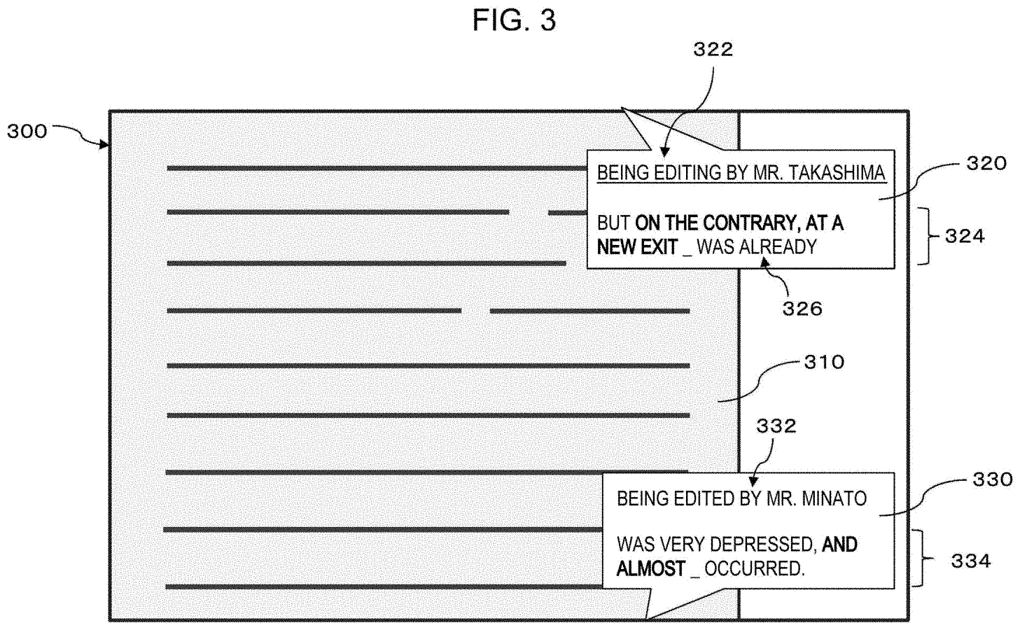

FIG. 3 schematically illustrates an editing screen 300 for a user. The editing screen 300 is generated by the document management server 100 in accordance with the process illustrated in FIG. 2.

A display region 310, which is part of a target document, is displayed on the editing screen 300. The target user is performing an editing operation on an input position (not illustrated in FIG. 3) in the display region 310.

At this time, for example, “Mr. Takashima”, who is a different user, is editing a part earlier than the display region 310 in the target document and another different user “Mr. Minato” is editing a part later than the display region 310. In this case, in the example illustrated in FIG. 3, an editing display 320 and an editing display 330 that indicate editing is being performed by different users are displayed in an upper end part and a lower end part of the display region 310.

The editing display 320 is a display notifying of information of the different user who is editing the part earlier than the display region 310. This display includes a message 322 indicating that “Mr. Takashima” is performing editing and document contents 324 of parts earlier and later than the current position of the input by the different user “Mr. Takashima” in the target document. In the display of the document contents 324, confirmed document contents earlier and later than the input position (in this example, a cursor 326) are indicated by thin characters and unconfirmed input contents (that is, a character string “on the contrary, at a new exit”) are highlighted by thick characters. The form of highlighting of unconfirmed input contents is not limited to thick characters.

The editing display 330 is a display notifying of information of the different user who is editing the part later than the display region 310. This display includes, as with the editing display 320, a message 332 indicating that “Mr. Minato” is performing editing and document contents 334 of parts earlier and later than the current position of the input by the different user “Mr. Minato” in the target document.

The process and the display form of the editing screen explained above with reference to FIGS. 2 and 3 are merely examples.

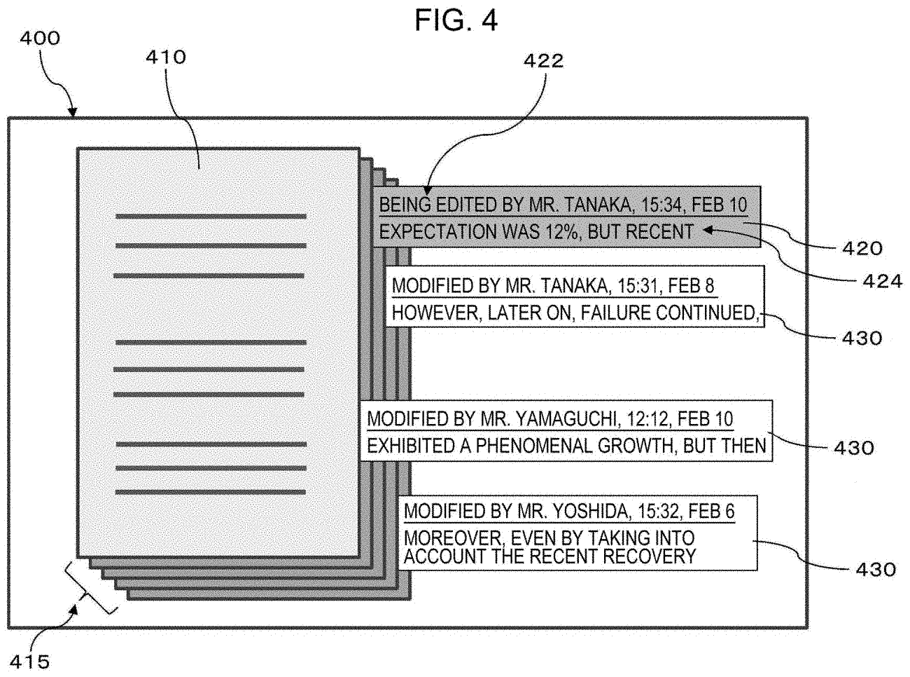

Next, another example of the editing screen provided to the client 200 by the document management server 100 according to this exemplary embodiment will be described with reference to FIG. 4.

On an editing screen 400 schematically illustrated in FIG. 4, document contents of a page 410 in the target document that is currently being edited by the target user is displayed. That is, in this example, the display region displayed on the editing screen 400 is a page.

In this example, a thickness image 415 schematically expressing the thickness (that is, the number of pages) of the target document is added along lower and right sides of the page 410. The target user performs input for editing on an input position in the page 410. The thickness image 415 is an example of a “representation image” representing a plurality of pages in the target document.

In this example, the different user “Mr. Tanaka” is currently performing editing on a page (hereinafter, referred to as a “page A”) different from the page 410. A tag image 420 representing a status of the editing is added to the thickness image 415 on the right side of the page 410. The tag image 420 is an image resembling a tag attached to the page A in the target document. That is, the tag image 420 is added, along a thickness direction of the thickness image 415, at a position corresponding to the page A in a page group represented by the thickness image 415. Furthermore, the position of the tag image 420 in terms of a vertical direction of the page 410 represents the position of the input by the different user “Mr. Tanaka” in the page A. In this example, text in the page 410 is arranged from the top to the bottom, and the vertical position of a row corresponding to the position of the input by “Mr. Tanaka” is represented by the vertical position of the tag image 420 along a direction in which the right side of the page 410 extends (that is, a vertical direction in FIG. 4).

In the tag image 420, a message 422 indicating that the corresponding different user is performing editing and input contents 424 of parts earlier and later than the current position of the input by the corresponding different user. The message 422 may include information of the date and time at which the input contents 424 were input. Furthermore, the input contents 424 may be displayed such that a confirmed part and an unconfirmed part may be able to be distinguished from each other.

Furthermore, a tag image 430 indicating a history of editing performed on the target document by a different user within a period from the last time the target user closed the target document to the present time is added to the thickness image 415 on the right side of the page 410. The tag image 430 indicating an editing history represents contents of editing reflected in the target document in the document DB 120. The tag image 430 includes information for identifying a user who performed the editing, the time and date at which the editing was performed, and contents of the editing (that is, information of a character string or the like added or deleted by the editing). In the example of FIG. 4, a message “Modified by Mr. Tanaka” is included as information for identifying the user who performed the editing.

The tag image 420 indicating information of the different user who is currently performing editing and the tag image 430 indicating an editing history are displayed in different display forms (for example, different colors, different flashing patterns, etc.).

Furthermore, the input contents 424 in the tag image 420 indicating the information of the different user who is currently performing the editing is updated in real time by the editing information display creation unit 110 in accordance with a further editing operation by the different user. That is, the input contents 424 indicate the latest contents input at the corresponding input position by the different user.

When the different user performs a confirmation operation on the input contents 424 for the input position corresponding to the tag image 420 indicating the information of the different user who is currently performing editing, the tag image 420 changes to the tag image 430 indicating an editing history. That is, in accordance with the confirmation operation, the input contents are reflected in a corresponding document in the document DB 120 by the user operation management unit 106. At the same time, an editing history is recorded, and the editing information display creation unit 110 displays, in place of the tag image 420, the tag image 430 indicating the editing history on the editing screen 400.

Furthermore, while the tag image 420 indicating that editing is currently being performed is displayed, if the different user ends the editing on the input position without performing a confirmation operation on the input contents displayed in the tag image 420, the tag image 420 disappears from the editing screen 400. Editing on an input position ends, for example, when the input position is moved to a different position or the different user closes the document.

When the user selects the tag image 420 or 430 on the editing screen 400, a page to which the selected tag image 420 or 430 is added is displayed. This page may be displayed on the editing screen 400 or may be displayed in a window different from the editing screen 400. In the case where the page is displayed on the editing screen 400, a graphical user interface (GUI) for returning to the original page (that is, the page on which editing is being performed by the target user) is displayed on the editing screen 400.

Display of a page corresponding to the selected tag image 420 or 430 is implemented when information of the selected tag image 420 or 430 is transmitted from the client 200 to the document management server 100. The display data creation unit 104 of the document management server 100 creates, based on a page number, an input position in the page, input contents or editing contents, and user information indicated by the transmitted information of the tag image 420 or 430, display data indicating a part including the input position in the corresponding page, and provides the created display data to the client 200. A part of the display data that corresponds to the input contents or editing contents indicated by the tag image 420 or 430 may be highlighted. The target user confirms, based on such display, what edit is being made or has been made to which page by the different user.

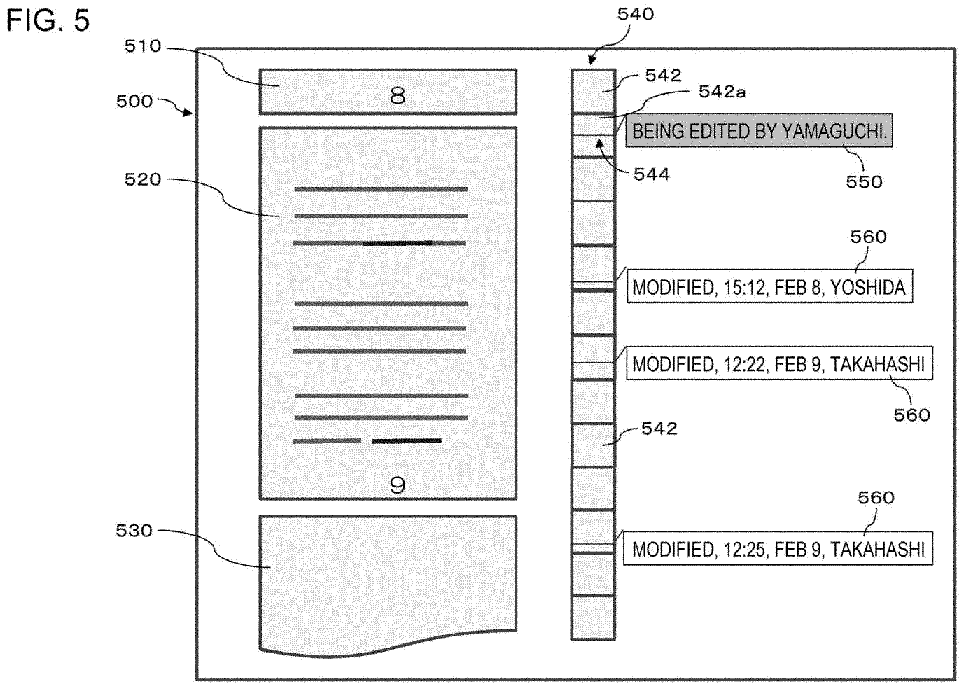

Next, another example of the editing screen provided to the client 200 by the document management server 100 according to this exemplary embodiment will be described with reference to FIG. 5.

In an editing screen 500 schematically illustrated in FIG. 5, document contents of the entire page 520 of the target document that is currently being edited by the target user are displayed. An image 510 representing an ending part of the page previous to the page 520 and an image 530 representing part of the beginning part of the page subsequent to the image 520 are displayed above and below the page 520. In the example illustrated in FIG. 5, the target user is currently editing the ninth page of the target document.

A page column image 540 is displayed next to the page 520 and so on. In the page column image 540, page icons 542 each representing a page in the target document are arranged in the order of page from the top to the bottom. The page column image 540 is an example of a representation image representing a plurality of pages included in the target document, and the page icons 542 are an example of page representation images each representing a page. In the page column image 540 on the editing screen 500, the page icons 542 for all the pages in the target document may be arranged. In the case where the target document has a large number of pages, a plurality of page column images 540 may be arranged so that the page icons 542 for all the pages in the target document may be displayed on the editing screen 500. Furthermore, as another example, a predetermined number of page icons 542 may be displayed in the page column image 540 on the editing screen 500, and a range of a page group for displaying the page icons 542 in the page column image 540 may be moved by a scroll operation.

In the example illustrated in FIG. 5, a different user “Yamaguchi” is currently performing editing on the second page of the target document. A “being edited” display 550 indicating a status of the editing is displayed in association with a page icon 542a for the second page in the page column image 540. A message “Being edited by Yamaguchi” is displayed in the “being edited” display 550, and the message indicates that a different user is currently editing a part of the target document that is different from the display region of the editing screen 500 and the username of the different user is “Yamaguchi”. Furthermore, as in the example illustrated in FIG. 4, contents of the current input by the different user corresponding to the input position may further be displayed in the “being edited” display 550.

Furthermore, in the example illustrated in FIG. 5, the page icon 542a and the “being edited” display 550 are associated with each other by connecting them by a line. A pair of the line connecting the page icon 542a with the “being edited” display 550 and the “being edited” display 550 is an example of a “specifying image” for specifying a page that is being edited by the different user. Furthermore, a horizontal line 544 drawn inside the page icon 542a represents the vertical position in the second page of the current position of the input by the different user “Yamaguchi”. As is clear from the display mentioned above, the different user “Yamaguchi” is editing substantially a center part of the second page.

Furthermore, apart from the “being edited” display 550 described above, an editing history display 560 indicating a history of editing performed on the target document by a different user within the period from the last time the target user closed the target document to the present time is displayed on the editing screen 500. The editing history display 560 indicates information of editing reflected in the target document in the document DB 120. The editing history display 560 regarding a recording of an editing history is displayed in association with the page icon 542 corresponding to a page on which editing represented by the record was performed. Furthermore, a horizontal line representing the vertical position of a part on which editing was performed in the page is displayed in the page icon 542. In the example illustrated in FIG. 5, the username of a user who performed the editing and the date and time at which the editing was performed are displayed in the editing history display 560. In addition to this, editing contents recorded in the record may further be displayed in the editing history display 560.

The “being edited” display 550 and the editing history display 560 are displayed in different display forms (for example, different colors, different flashing patterns, etc.).

Moreover, the “being edited” display 550 in the editing screen 500 behaves like the tag image 420 indicating information of editing being performed in the example of FIG. 4 described above.

In the example illustrated in FIG. 4 or FIG. 5, display of an editing history of a different user within the period from the last time the target user closed the target document to the present time (that is, the tag image 430 or the editing history display 560) may be divided more finely in terms of time. For example, display for editing performed by a different user within a period from the last time the target user closed the target document to the time when the target user opened the target document this time and display for editing performed by a different user within a period from the time when the target user opened the target document this time to the present time may be displayed in different display forms.

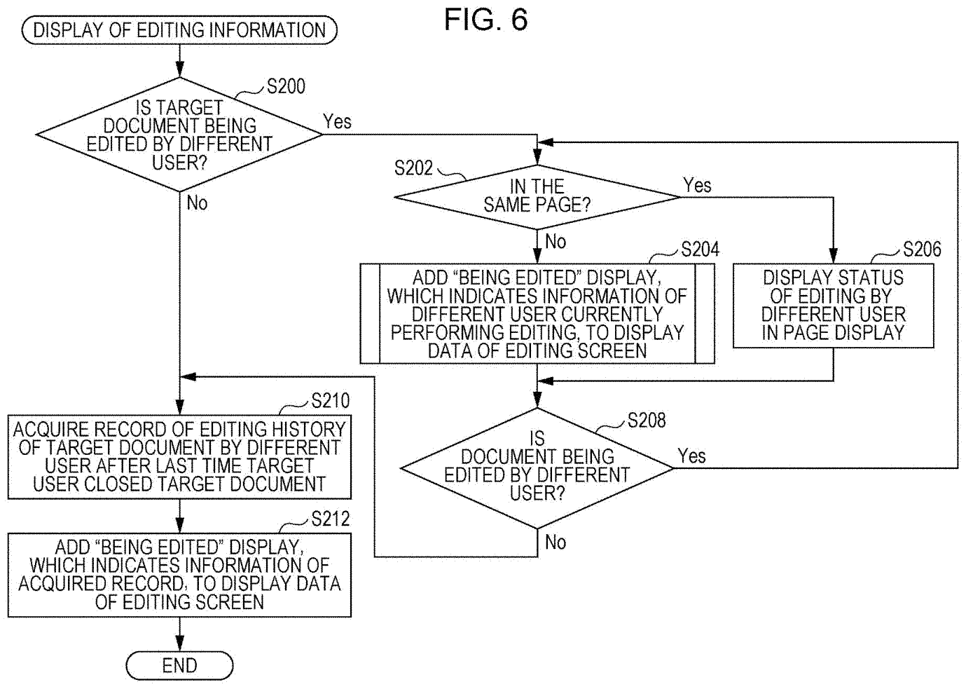

An example of a process performed by the document management server 100 to generate the editing screen 400 or 500 illustrated in FIG. 4 or FIG. 5 will be described below with reference to FIG. 6. The same assumption as that for the process illustrated in FIG. 2 is applied to the process illustrated in FIG. 6.

In the process illustrated in FIG. 6, the editing information determination unit 108 of the document management server 100 determines whether a different user is editing a target document (S200). This determination may be performed as in S100 of FIG. 2.

In the case where the determination result in S200 is Yes, the editing information determination unit 108 determines whether the position of an input by the different user who is performing editing determined in S200 is the same page as the page on which the target user is performing editing (S202).

In the case where the determination result in S202 is No, the editing information display creation unit 110 generates display information indicating a status of the editing currently being performed by the different user (that is, the tag image 420 or the “being edited” display 550), and adds the display information to the editing screen 400 or 500 (S204).

In the case where the determination result in S202 is Yes, the editing information display creation unit 110 displays, in the page 410 or 520 in the editing screen 400 or 500 on which the target user is performing editing, display information indicating the status of the editing currently being performed by the different user (S206). This display information represents, for example, the username of the different user and contents of the input by the different user displayed at the position of the input by the different user in the page 410 or 520.

After S204 or S206, the editing information determination unit 108 determines whether another different user editing the target document (S208). In the case where the determination result in S208 is Yes, the editing information determination unit 108 returns to S202 to determine whether the position of an input by the different user who is performing the editing determined in S208 is the same page as the page on which the target user is performing editing.

In the case where the determination result in S200 or S208 is No, the document management server 100 acquires from the document DB 120 a record of an editing history of a different user in which the editing date and time is later than the last time the target user closed the target document, out of records of editing histories of the target document (S210). The editing information display creation unit 110 generates the tag image 430 or the editing history display 560 for a record indicating editing on a page not displayed on the editing screen 400 or 500, out of the acquired records of editing histories. Then, the editing information display creation unit 110 adds the generated tag image 430 or editing history display 560 to the display data of the editing screen 400 or 500 (S212).

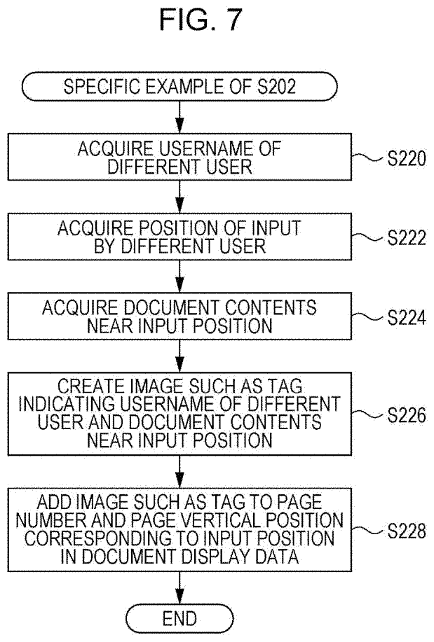

FIG. 7 illustrates an example of the details of processing of S202 in the process illustrated in FIG. 6.

In the processing illustrated in FIG. 7, the editing information display creation unit 110 acquires the username of the different user who is performing editing determined in S200 or S208 from the user operation management unit 106 (S220). The editing information display creation unit 110 also acquires information of the current position of an input by the different user from the user operation management unit 106 (S222). The editing information display creation unit 110 also acquires document contents of parts earlier and later than the current position of the input by the different user from the user operation management unit 106 (S224). The document contents acquired at this time may include a part reflected in the document DB 120 and contents of the input by the different user for the input position (that is, an unconfirmed part, in other words, a part that has not yet been reflected in the document DB 120).

The editing information display creation unit 110 creates the tag image 420 or the “being edited” display 550 indicating the username acquired in S220 and the document contents acquired in S224 (S226). Then, the editing information display creation unit 110 adds the created tag image 420 or “being edited” display 550 to the display data of the editing screen 400 or 500 in association with the vertical position of the input position in the page indicated by the input position acquired in S222 (S228).

In S228, the display form of the tag image 420 or the “being edited” display 550 may be different between display of editing performed by a different user within a period from the last time the target user closed the target document to the time when the target user opened the target document this time and display of editing performed by a different user within a period from the time when the target user opened the target document this time to the present time.

In the processes illustrated in FIGS. 2 and 6, only input contents currently being edited by a different user (that is, unconfirmed contents) are treated as contents “being edited”. However, as another example, if the editing date and time of an editing history of editing contents on which a different user has performed a confirmation operation is less than predetermined minutes (for example, five minutes) before the present time, such an editing history may be displayed as “being edited”. In this example, information of an editing history of a different user in which the editing date and time is less than the predetermined time before the present time is displayed in the same display form as that for the tag image 420 or the “being edited” display 550. Then, when the time passes and the editing date and time of the editing history becomes equal to or more than the predetermined time before the editing time of the editing history, display indicating the editing history is changed to the display form of the tag image 430 or the editing history display 560.

The document management server 100 and the client 200 described above according to the exemplary embodiments are implemented when a computer is caused to execute a program representing functions of an element group configuring the document management server 100 or the client 200 described above. The computer has a circuit configuration in which, for example, a processor, a controller that controls a memory (main storage device) such as a random access memory (RAM) and an auxiliary storage device such as a flash memory, a solid-state drive (SSD), or a hard disk drive (HDD), various input/output (I/O) interfaces, a network interface that performs control for connection with a network such as a local area network, and so on are connected to one another via, for example, a bus. The program in which processing details of each of the functions is described is stored in the auxiliary storage device via a network or the like and installed into the computer. When the program stored in the fixed storage device is read onto the memory and executed by the processor, the above-mentioned functional module group is implemented.

In the embodiments above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiments and reference examples above, the term “processor” is broad enough to encompass one processor or plural processors in collaboration which are located physically apart from each other but may work cooperatively. The operations of the processor (that is, processing operations of the elements illustrated in FIG. 1 implemented by an operation of the processor) are not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
an editing reception unit that provides to each user an editing screen on which at least one part of a document is displayed and receives from the user editing on the at least one part of the document displayed on the editing screen being provided to the user; and
a providing unit that provides to the user information regarding editing currently being performed by a different user on a part of the document not displayed on the editing screen being provided to the user.

2. The information processing apparatus according to claim 1, wherein the providing unit provides, as information regarding the editing, different user editing position information indicating a position of the part in the document on which the editing is currently being performed by the different user.

3. The information processing apparatus according to claim 2, wherein the providing unit provides, as the different user editing position information, information for specifying a page on which the editing is currently being performed by the different user.

4. The information processing apparatus according to claim 3,
wherein on the editing screen, a page image representing contents of a page in the document as the at least one part of the document and a representation image representing a plurality of pages included in the document are displayed, and
wherein the providing unit provides, as the different user editing position information, a page position image representing a position in the representation image that corresponds to the page on which the editing is currently being performed by the different user.

5. The information processing apparatus according to claim 4,
wherein the representation image is a thickness image representing a thickness of the plurality of pages on at least one side of the page image, and
wherein the providing unit provides, as the page position image, a tag image displayed in association with a position of the page on which the editing is currently being performed by the different user in a direction of the thickness in the thickness image.

6. The information processing apparatus according to claim 5, wherein the providing unit displays the tag image at a position on which the editing is currently being performed by the different user in the page on which the editing is currently being performed by the different user, along a direction in which the side of the page image to which the thickness image is added extends.

7. The information processing apparatus according to claim 4,
wherein the representation image is obtained by arranging page representation images in a page order, the page representation images representing the plurality of pages, and
wherein the providing unit provides, as the page position image, a specifying image for specifying the page representation image in the representation image corresponding to the page on which the editing is currently being performed by the different user.

8. The information processing apparatus according to claim 7, wherein the providing unit further displays an image for specifying a position in the page on which the editing is currently being performed by the different user on the page representation image corresponding to the page on which the editing is currently being performed by the different user.

9. The information processing apparatus according to claim 1, wherein information regarding the editing includes at least one of user information for identifying the different user and editing contents information indicating contents of the editing currently being performed by the different user.

10. The information processing apparatus according to claim 2, wherein information regarding the editing includes at least one of user information for identifying the different user and editing contents information indicating contents of the editing currently being performed by the different user.

11. The information processing apparatus according to claim 9, wherein the editing contents information is updated in real time in accordance with the editing currently being performed by the different user.

12. The information processing apparatus according to claim 10, wherein the editing contents information is updated in real time in accordance with the editing currently being performed by the different user.

13. The information processing apparatus according to claim 11, wherein when a specific time has passed since completion of real-time update of the editing contents information, the contents of the editing indicated by the editing contents information become displayed in a display form different from that of the editing contents information.

14. The information processing apparatus according to claim 12, wherein when a specific time has passed since completion of real-time update of the editing contents information, the contents of the editing indicated by the editing contents information become displayed in a display form different from that of the editing contents information.

15. The information processing apparatus according to claim 2, wherein the providing unit provides, as the different user editing position information, information indicating whether a position of the part in the document on which the editing is currently being performed by the different user is earlier or later than the at least one part displayed on the editing screen.

16. The information processing apparatus according to claim 1, further comprising:
a second providing unit that provides to the user information regarding editing performed on a part of the document not displayed on the editing screen being provided to the user by a different user within a period from last closing of the document by the user to current opening of the document by the user in a display form different from that of the information regarding the editing currently being performed by the different user.

17. The information processing apparatus according to claim 2, further comprising:
a second providing unit that provides to the user information regarding editing performed on a part of the document not displayed on the editing screen being provided to the user by a different user within a period from last closing of the document by the user to current opening of the document by the user in a display form different from that of the information regarding the editing currently being performed by the different user.

18. The information processing apparatus according to claim 3, further comprising:
a second providing unit that provides to the user information regarding editing performed on a part of the document not displayed on the editing screen being provided to the user by a different user within a period from last closing of the document by the user to current opening of the document by the user in a display form different from that of the information regarding the editing currently being performed by the different user.

19. The information processing apparatus according to claim 4, further comprising:
a second providing unit that provides to the user information regarding editing performed on a part of the document not displayed on the editing screen being provided to the user by a different user within a period from last closing of the document by the user to current opening of the document by the user in a display form different from that of the information regarding the editing currently being performed by the different user.

20. A non-transitory computer readable medium storing a program causing a computer to execute a process for information processing, the process comprising:
providing to each user an editing screen on which at least one part of a document is displayed and receiving from the user editing on the at least one part of the document displayed on the editing screen being provided to the user; and
providing to the user information regarding editing currently being performed by a different user on a part of the document not displayed on the editing screen being provided to the user.
